(19) United States
(12) Patent Application Publication
(10) Pub. No.: US 2005/0181215 A1
(43) Pub. Date: Aug. 18, 2005

(54) Thermosetting resin compositions and film articles

(75) Inventors: Tetsuaki Suzuki, Iruma-shi (JP); Naoya Kakiuchi, Iruma-shi (JP); Yasuhiro Noda, Iruma-shi (JP); Yusuke Tanahashi, Iruma-shi (JP)

Correspondence Address: OLIFF & BERRIDGE, PLC, P.O. BOX 19928, ALEXANDRIA, VA, 22320, US

(73) Assignee: TAMURA KAKEN CORPORATION, Iruma-shi (JP)

(21) Appl. No.: 11/038,531

(22) Filed: Jan. 21, 2005

(30) Foreign Application Priority Data
Feb. 2, 2004 (JP) P2004-025986
Jan. 13, 2005 (JP) P2005-006239

(51) Int. Cl. B32B 27/38; B32B 15/08; C08L 63/00; C08L 83/10

(52) U.S. Cl. 428/418; 428/447; 428/473.5; 428/474.4; 525/476

(57) ABSTRACT

A thermosetting resin composition comprises (a) epoxy resin, (b) setting agents comprising a novolak-type phenol resin and a benzooxazine compound and (c) a siloxane-modified polyamide-imide resin satisfying the following relationship. 0.6≦m+n≦2, 0.5≦m≦1.2, and 0.1≦n≦1.0 (“m” represents the hydroxyl group equivalent of (b) said novolak-type phenol resin with respect to the epoxy equivalent of (a) said epoxy resin of 1, and “n” represents the hydroxyl group equivalent of (b) the benzooxazine compound after thermal decomposition with respect to the epoxy equivalent of (a) the epoxy resin of 1. The thermosetting resin composition comprises (c) the siloxane-modified polyamide-imide resin in a content of 2 to 50 weight parts with respect to the total content of (a) the epoxy resin and (b) the setting agents of 100 weight parts.

This application claims the benefits of Japanese Patent Applications P2004-25986, filed on Feb. 2, 2004, and P2005-6239, filed on Jan. 13, 2005, the entireties of which are incorporated by reference.

### BACKGROUND OF THE INVENTION

1. Technical Field

The present invention relates to a thermosetting resin composition used for an adhesive, prepreg, paint or the like and, in particular, used for producing a printed circuit board produced by semiadditive process or fully additive process. The present invention further provides a film of B-stage resin produced by using the above resin composition, a resin film having a heat resistant film and B-stage resin produced by applying the above resin composition on the one or both side of the heat resistant film, and a metal foil having B-stage adhesive applied on the one side of the metal foil. The resin composition, resin film and metal foil may be used for a high density build-up printed wiring board having a low dielectric constant, low dielectric loss tangent, low thermal expansion, high adhesion strength, high thermal resistance and excellent reliability. The thus obtained printed wiring board may be used for a semiconductor plastic package or the like.

2. Related Art Statement

It has been recently demanded to lower the dielectric constant and dielectric loss tangent of a package substrate for MPU or ASIC for realizing high speed processing and responding to operation at a high frequency, as well as a reduction of line pitch, smaller diameter, narrower pad pitch and the increase of number of layers. It is required a high density build-up substrate or high density integrated-shaped substrate on the viewpoint of the substrate structure. It is also required to apply additive process instead of subtractive process for realizing a lower wire diameter, and to provide a smaller laser via for realizing a smaller diameter and narrower pad pitch. It is further required to lower the thermal expansion coefficient for improving the reliability and dimensional and positional precisions. Further, for realizing operation at higher frequency, it is required to lower the dielectric constant and dielectric loss tangent for reducing the transmission loss and to lower the surface roughness for reducing the skin effect due to conductor processing profile. It has been known, for example, film products described in the following documents proposed for solving the above problems.
Japanese patent publication 11-1547A
Japanese patent publication 11-87927A
Japanese patent publication 2000-17148A
Japanese patent publication 2000-198907A
Japanese patent publication 2003-238772A
Japanese patent publication 2001-181375A
Japanese patent publication 2002-241590A
Japanese patent publication 2002-309200A
Japanese patent publication 2003-127313A
Japanese patent publication 2003-321607A

### SUMMARY OF THE INVENTION

It has not been known, however, a material satisfying all the above listed requirements up to now. It is particularly true in a layer insulation material for use in a build-up substrate. That is, it has not been known a thermosetting resin composition having a low dielectric constant, a low dielectric loss tangent, a low thermal expansion coefficient and an excellent peel strength at a low surface roughness after roughening adapted to additive process.

An object of the present invention is to provide a thermosetting resin composition having a low dielectric constant, a low dielectric loss tangent, a low thermal expansion coefficient and an excellent peel strength at a low surface roughness after roughening adapted to additive process.

Another object of the present invention is to provide a high density build-up printed wiring board produced by using the above thermosetting resin composition as the layer insulating material.

The thermosetting resin composition of the present invention comprises (a) epoxy resin, (b) setting agents comprising a novolak-type phenol resin and a benzooxazine compound, and (c) a siloxane-modified polyamide-imide resin, and satisfies the following formulae.
0.6≦m+n≦2
0.5≦m≦1.2, and
0.1≦n≦1.0

In the formulae, “m” represents the hydroxyl group equivalent of (b) said novolak-type phenol resin with respect to the epoxy equivalent of (a) said epoxy resin of 1, and “n” represents the hydroxyl group equivalent of (b) said benzooxazine compound after thermal decomposition with respect to the epoxy equivalent of (a) said epoxy resin of 1. The thermosetting resin composition comprises (c) said siloxane-modified polyamide-imide resin in a content of 2 to 50 weight parts with respect to the total content of (a) said epoxy resin and (b) said setting agents of 100 weight parts.

According to the present invention, the base resin of the thermosetting resin composition is changed from prior bisphenol-A type epoxy resin to epoxy resin of rigid structure such as dicyclopentadiene type resin, and a novolak-type phenol resin and a benzooxazine compound are used as setting agents. It is found that such combination of the base resin and setting agents can realize a low dielectric constant, a low dielectric loss tangent and a low thermal expansion coefficient.

It is further found that the resulting cured product is insufficient in some film properties as follows. It has been blended a high molecular weight compound such as a rubber compound or a phenoxy resin for improving the film properties up to now. It is, however, found that such prior compounds reduce the dielectric properties of the film and thus cannot be used in a large amount in the resin composition of the present invention. The inventors have tried to use a siloxane-modified polyamide-imide resin in the combination of the base resin and setting agents and successfully provided flexibility to the cured product and improve the film properties without deteriorating the dielectric properties. It is further found that the adhesive strength of the resin composition itself can be improved by the addition of the siloxane-modified polyamide-imide resin so that roughened face with a low profile can be realized while using prior roughening agents.

The inventive thermosetting resin composition thus provides, for example, an interlayer insulating material having a low dielectric constant, a low dielectric loss tangent, and an excellent peel strength at a low surface roughness after roughening, adapted to additive process.

These and other objects, features and advantages of the invention will be appreciated upon reading the following description of the invention when taken in conjunction with the attached drawings, with the understanding that some modifications, variations and changes of the same could be made by the skilled person in the art.

### PREFERRED EMBODIMENTS OF THE INVENTION

According to the present invention, (a) epoxy resin includes epoxy resin having two or more glycidyl groups and rigid structure. (a) epoxy resin may preferably be a biphenyl type epoxy resin, naphthalene type epoxy resin, dicyclopentadiene type epoxy resin or the like, which may be used alone or in combination. The dielectric constant and dielectric loss tangent are substantially influenced by the main bone structure of the epoxy resin (a) and the concentration of hydroxyl groups. The epoxy group (a) may preferably have a higher epoxy equivalent in those having the same kind of structure. Further, (a) epoxy resin is selected from epoxy resins other than (d) high molecular weight epoxy resin described later. The molecular weight (Mw) of the epoxy resin (a) may preferably be lower than 10000, more preferably be 9900 or lower and most preferably be 5000 or lower.

According to the present invention, the novolak-type phenol resin used as the setting agent (b) includes triazine-modified novolak-type resins such as benzoguanamine-modified bisphenol A-type novolak resin, benzoguanamine-modified cresol novolak type resin, benzoguanamine-modified phenol novolak type phenol resin, melamine-modified bisphenol-A type novolak resin, melamine-modified cresol novolak type phenol resin, melamine-modified phenol novolak type resin; resins having naphthalene and aralkyl moieties such as 1-natphtol aralkyl resin, 2-naphthol aralkyl resin, 1,6-naphthalene diol aralkyl resin and so on.

The benzooxazine compound used as the setting agent (b) in the present invention is not particularly limited. The benzooxazine compound may preferably be compounds represented by formulae (1) and (2), the isomers of the compounds represented by the formulae 1 and (2), and the oligomers of the compounds. Such benzooxazine compound is subjected to ring-opening reaction on heat to generate a phenolic hydroxyl group and a tertially amine, so that benzooxazine compound is expected to act as a setting agent for epoxy resin. Since the benzooxazine compound may be subjected to ring-opening polymerization with heat, however, the structure of the benzooxazine compound is limited for use as the setting agent. In other words, the benzooxazine compounds capable of ring-opening polymerization at a low temperature is not suitable as the setting agent. On the viewpoint, it is preferred the benzooxazine compound can perform ring-opening polymerization only at a temperature of 100° C. or higher.

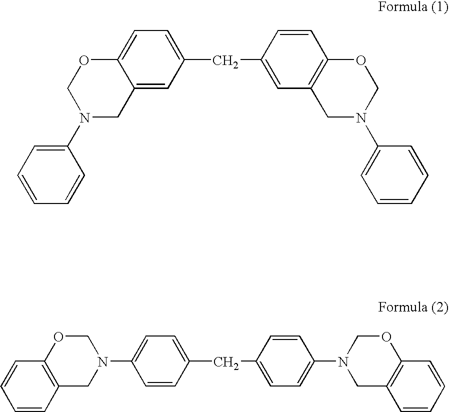

The used amount (hydroxyl group equivalent) of the setting agent (b) (total amount of the novolak-type phenol resin and benzooxazine compound) may preferably be 0.6 to 2, provided that 1 eq is assigned to the epoxy equivalent of the epoxy resin (a). If the used amount of the setting agent (total amount: hydroxyl group equivalent) is lower than 0.6 eq, appropriate Tg, low dielectric constant and low dielectric loss tangent cannot be obtained. If the used amount of the setting agent (total amount: hydroxyl group equivalent) exceeds 2 eq, the water absorbing capacity of the resin composition is deteriorated so that the curing of the resin composition is delayed.

The amount of the novolak-type phenol resin is 0.5 eq or higher and 1.2 eq or lower as hydroxyl group equivalent, provided that 1 eq is assigned to the epoxy equivalent of the epoxy resin (a). If the used amount of the novolak-type phenol resin is lower than 0.5 eq, appropriate Tg cannot be obtained. The amount of novolak-type phenol resin is thus made 0.5 eq or higher and may preferably be 0.6 eq or higher. Further, if the used amount of the novolak-type phenol resin exceeds 1.2 eq, the water absorbing capacity of the resin composition is deteriorated. The amount of the novolak-type phenol resin is thus made 1.2 eq or lower and may preferably be 1.0 eq or lower.

The amount of the benzooxazine compound as hydroxyl group equivalent is 0.1 eq or higher and 1.0 eq or lower with respect to the epoxy equivalent of the epoxy resin (a) of 1. If the used amount of the benzooxazine compound is lower than 0.1 eq, the dielectric constant, dielectric loss tangent and thermal expansion coefficient of the resin are not effectively lowered. The used amount of the benzooxazine compound is thus made 0.1 eq or higher and may preferably be 0.2 eq or higher. Further, if the used amount of the benzooxazine compound exceeds 1 eq, the setting time of the resin composition is substantially delayed and may preferably be 0.7 eq or lower.

In particular, the triazine-modified novolak-type resin among the setting agents listed above can produce a cured product having dielectric constant and dielectric loss tangent lower than those of cured product of prior novolak-type resin. Further, the benzooxazine compound can provide cured product having lower dielectric constant, dielectric loss tangent and thermal expansion coefficient. The benzooxazine compound as the setting agent is, however, inferior in the reactivity with the epoxy resin and tends to easily perform ring-opening polymerization. It is found that the combination of setting agents of the benzooxazine compound and triazine-modified novolak-type resin according to the present invention can provide cured product exhibiting the most superior properties.

According to the present invention, the siloxane-modified polyamide-imide resin (c) is obtained by the following process. That is, trimellitic anhydride and a mixture of a diamine and siloxane diamine each having three or more aromatic rings are reacted to obtain a mixture containing diimide carboxylic acid, which is then reacted with an aromatic diisocyanate to obtain the siloxane-modified polyamide-imide resin. The amount of the siloxane-modified polyamide-imide resin (c) is selected in a range of 2 to 50 weight parts, provided that 100 weight parts is assigned to the total amount of the epoxy resin (a) and setting agent (b). If the amount of the polyamide-imide resin is lower than 2 weight parts, it is not effective for the improvement of the adhesive strength and flexibility. The amount of the polyamide-imide resin is thus made 2 weight part or higher, and may preferably be 5 weight parts or higher. Further, if the amount of the polyamide-imide resin exceeds 50 weight parts, the breaking strength of the resulting film produced by the resin composition is lowered. The amount of the polyamide-imide resin is made 50 weight parts or lower, and may preferably be 30 weight parts or lower.

According to the composition of the present invention, a high molecular weight epoxy resin or phenoxy resin (d) may be used. It is possible to improve the flexibility of the resulting cured product by adding the high molecular weight epoxy or phenoxy resin (d), as in the case of the addition of the siloxane-modified polyamide-imide resin (c). The addition of (d), however, tends to deteriorate the dielectric constant and dielectric loss tangent. The amount of (d) may be also decided on the economical point of view. The used amount of (d) may preferably be not higher than that of the siloxane-modified polyamide-imide resin (c), and more preferably be 60 weight parts or lower provided that 100 weight parts are assigned to the weight of (c), for improving the dielectric constant and dielectric loss tangent. When the amount of (d) exceeds that of (c), the dielectric constant, dielectric loss tangent and Tg tends to be deteriorated.

Further, the high molecular weight epoxy or phenoxy resin (d) may preferably have a molecular weight (Mw) of 10000 or higher, and its resin structure may preferably be BPA, BPA/BPF, BPA/BPS, BP/BPS types or the like.

The filler (e) may be added into the composition according to the present invention. The filler (e) is defined as a compound having a difference in solubility compared with the cured product of (a), (b), (c) and optionally (d) in a surface roughening process. Specifically, the filler (e) may preferably be fillers of low dielectric constants such as silica, PTFE (poly tetrafluoro ethylene), methyl silicone, polystyrene or polyphenylene ether. Further, the amount of the filler (e) may preferably be 0 to 100 weight parts, provided that 100 weight parts are assigned to the total amount of the epoxy resin (a), setting agents (b), siloxane-modified polyamide-imide resin (c) and the high molecular weight epoxy or phenoxy resin (d). Although any filler may be selected on the viewpoint of the low dielectric constant and low dielectric loss tangent, filler mainly composed of silica is preferred for lowering the thermal expansion coefficient. In this case, the filler mainly composed of silica may be subjected to a surface treatment with, for example, epoxy silane, amino silane, vinyl silane or the like. The particle diameter of the filler may preferably be 0.5 micrometer or lower on the viewpoint of responding to narrower pitch (L/S≦50/50 μm) and reducing the surface roughness (Ra≦0.5 μm). 10 weight parts or more of the silica filler may preferably added for improving the peel strength of the resulting film to a value of 0.5 kN/m or larger. Further, if the filler is added in an amount higher than 100 weight parts, the ease of processing with laser is deteriorated. The amount of the filler may preferably be 100 weight parts or lower.

A hardening accelerator may be optionally used in the composition according to the present invention. Various kinds of conventional compounds such as imidazole compounds may be used as the hardening accelerator. The accelerator is selected mainly depending on the reaction speed and pot life.

Further, a flame retarder may be added to the composition according to the present invention for imparting the flame retarding property. Flame retarders free of halogen include condensation type phosphoric esters, phosphazenes, polyphosphates, HCA (9, 10-dihydro-9-oxa-10-phosphaphenanthrene-10- oxide) or the like.

Solvents usable in the resin composition according to the present invention is not particularly limited. The solvents may preferably a mixture of a solvent having a high boiling point gum as NMP or diethylene glycol monomethyl ether acetate and a solvent having a low boiling point such as cyclohexanone and MEK.

The thermal resin composition according to the present invention may be formed into a B-stage resin film. That is, the resin composition of the present invention is used to produce a thermosetting resin film in B-stage by means of a conventional process. For example, the resin composition is diluted with an appropriate organic solvents such as a mixed solvent of NMP (diethylene glycol monomethyl ether acetate)/MEK (cyclohexanone) or the like to produce varnish. The varnish is then applied onto a polyethylene terephthalate film (PET film), optionally subjected to mold releasing process in advance, using a die coater and heated to obtain the film.

The thermosetting resin film in B-stage is a semi-cured film at a stage between A-stage (non-cured) and C-stage (fully cured).

Alternatively, the thermosetting resin composition of the invention may be applied onto the either side or both sides of a surface treated film such as full aromatic amide film or full aromatic polyester film to produce a thermosetting resin film in B-stage, on the substrate film base, having a still lower thermal expansion coefficient. The full aromatic amide polymer includes polyparaphenylene terephthalic amide (PPTA). The full aromatic polyester polymer includes compounds having 2-hydroxy-6-naphthoic acid moiety or p-hydroxy benzoic acid moiety.

Alternatively, the thermosetting resin composition according to the present invention may be applied onto a metal foil to produce a metal foil coated with an adhesive. Such metal foil includes a copper foil and aluminum foil subjected to surface roughening and more preferably be copper foil.

The product with the film according to the present invention may be used for a printed wiring hoard having a non-through via hole such as a laser via as an HDI material of a build-up multi-layer board.

### EXAMPLES

The present invention will be described further in detail.

### Example 1

It was produced a mixture of 372 weight parts of dicyclopentadiene type epoxy resin “HP-7200H” (manufactured by DAINIPPON INK AND CHEMICALS, INCORPORATED: epoxy equivalent is 283: solid content of the resin is 80 weight percent), 160 weight parts of melamine-modified cresol novolak resin “EXB-9854” (manufactured by DAINIPPON INK AND CHEMICALS, INCORPORATED: hydroxyl value is 151: solid content of the resin is 80 weight percent), 60 weight parts of benzooxazine compound “F-a” (manufactured by Shikoku Chemicals Corporation), 216 weight parts of siloxane-modified polyamide-imide resin (supplied by Hitachi Chemical Co., Ltd.: amide equivalent is 620: Mw=about 80000: solid content in resin is 28 weight percent), 55 weight parts of condensation type phosphoric ester “PX-200” (manufactured by DAIHACHI CHEMICAL INDUSTRY CO., LTD.), 0.7 weight parts of 2-ethyl-4-methyl imidazole and 120 weight parts of silica (average diameter of 0.3 μm). To the mixture, a mixed solvent of NMP/MEK was added to produce resin varnish having a solid content of 60 weight percent.

### Example 2

It was produced a mixture of 362 weight parts of biphenyl type epoxy resin “NC-3000H” (manufactured by NIPPON KAYAKU CO., LTD.: epoxy equivalent is 275: solid content of the resin is 80 weight percent), 177 weight parts of melamine-modified phenol novolak resin “LA-7054” (manufactured by DAINIPPON INK AND CHEMICALS, INCORPORATED: hydroxyl value is 125: solid content of the resin is 60 weight percent), 60 weight parts of benzooxazine compound “F-a” (manufactured by Shikoku Chemicals Corporation), 216 weight parts of siloxane-modified polyamide-imide resin (manufactured by Hitachi Chemical Co., Ltd.: amide equivalent is 620: Mw=about 80000: solid content in resin is 28 weight percent), 55 weight parts of condensation type phosphoric ester “PX-200” (manufactured by DAIHACHI CHEMICAL INDUSTRY CO., LTD. ), 1.0 weight part of 1-cyano-2-undecyl imidazole and 120 weight parts of silica filler treated with epoxy silane (average diameter of 0.3 μm). To the mixture, a mixed solvent of NMP/MEK was added to produce resin varnish having a solid content of 60 weight percent.

### Example 3

It was produced a mixture of 349 weight parts of naphthol aralkyl type epoxy resin “ESN-165” manufactured by Tohto Chemical CO., LTD.: epoxy equivalent is 265: solid content of the resin is 80 weight percent), 177 weight parts of melamine-modified phenol novolak resin “LA-7054” (manufactured by DAINIPPON INK AND CHEMICALS, INCORPORATED: hydroxyl value is 125: solid content of the resin is 60 weight percent), 60 weight parts of benzooxazine compound “F-a” (manufactured by Shikoku Chemicals Corporation), 216 weight parts of siloxane-modified polyamide-imide resin (supplied by Hitachi Chemical Co., Ltd.: Mw=about 80000: amide equivalent is 620: solid content in resin is 28 weight percent), 55 weight parts of condensation type phosphoric ester “PX-200” (manufactured by DAIHACHI CHEMICAL INDUSTRY CO., LTD).), 1.2 weight part of 2-phenyl-4,5-dihydroxy methyl imidazole and 120 weight parts of silica filler (average diameter of 0.3 μm). To the mixture, a mixed solvent of NMP/MEK was added to produce resin varnish having a solid content of 60 weight percent.

### Example 4

It was produced a mixture of 362 weight parts of biphenyl type epoxy resin “NC-3000H” (manufactured by NIPPON KAYAKU CO., LTD.: epoxy equivalent is 275: solid content of the resin is 80 weight percent), 177 weight parts of melamine-modified phenol novolak resin “LA-7054” (Manufactured by DAINIPPON INK AND CHEMICALS, INCORPORATED: hydroxyl value is 125: solid content of the resin is 60 weight percent), 60 weight parts of benzooxazine compound “P-d” manufactured by Shikoku Chemicals Corporation), 216 weight parts of siloxane-modified polyamide-imide resin (supplied by Hitachi Chemical Co., Ltd.: amide equivalent is 620: Mw=about 80000: solid content in resin is 28 weight percent), 55 weight parts of condensation type phosphoric ester “PX-200” (manufactured by DAIHACHI CHEMICAL INDUSTRY CO., LTD. ), 0.7 weight parts of 2-ethyl-4-methyl-imidazole and 120 weight parts of PPE filler “YPL-100LP” (manufactured by Mitsubishi Gas Chemical Company, Inc.). To the mixture, a mixed solvent of NMP/MEK was added to produce resin varnish having a solid content of 60 weight percent.

### Example 5

It was produced a mixture of 372 weight parts of dicyclopentadiene type epoxy resin “HP-7200H” (manufactured by DAINIPPON INK AND CHEMICALS, INCORPORATED: epoxy equivalent is 283: solid content of the resin is 80 weight percent), 182 weight parts of 1-naphthol aralkyl resin “SN-485” (manufactured by Tohto Chemical CO., LTD.: hydroxyl value is 215), 60 weight parts of benzooxazine compound “F-a” (manufactured by Shikoku Chemicals Corporation), 216 weight parts of siloxane-modified polyamide-imide resin (supplied by Hitachi Chemical Co., Ltd.: amide equivalent is 620: Mw=about 80000: solid content in resin is 28 weight percent), 55 weight parts of condensation type phosphoric ester “PX-200” (manufactured by DAIHACHI CHEMICAL INDUSTRY CO., LTD.), 0.7 weight parts of 2-ethyl-4-methyl-imidazole and 120 weight parts of silica filler (average diameter of 0.3 μm). To the mixture, a mixed solvent of NMP/MEK was added to produce resin varnish having a solid content of 60 weight percent.

### Example 6

It was produced a mixture of 372 weight parts of dicyclopentadiene type epoxy resin “HP-7200H” (manufactured by DAINIPPON INK AND CHEMICALS, INCORPORATED: epoxy equivalent is 283: solid content of the resin is 80 weight percent), 160 weight parts of melamine-modified cresol novolak resin “EXB-9854” (manufactured by DAINIPPON INK AND CHEMICALS, INCORPORATED: hydroxyl value is 151: solid content of the resin is 80 weight percent), 60 weight parts of benzooxazine compound “F-a” (manufactured by Shikoku Chemicals Corporation), 145 weight parts of siloxane-modified polyamide-imide resin (supplied by Hitachi Chemical Co., Ltd.: amide equivalent is 620: Mw=about 80000: solid content in resin is 28 weight percent), 67 weight parts of high molecular weight epoxy resin “YPS-007A30” (manufactured by Tohto chemical Co. Ltd.: Mw=about 40000: solid content in resin is 30 weight percent), 55 weight parts of condensation type phosphoric ester “PX-200” (manufactured by DAIHACHI CHEMICAL INDUSTRY CO., LTD.), 0.7 weight part of 2-ethyl-4-methyl-imidazole and 120 weight parts of silica filler (average diameter of 0.3 μm). To the mixture, a mixed solvent of NMP/MEK was added to produce resin varnish having a solid content of 60 weight percent.

### Example 7

It was produced a mixture of 260 weight parts of dicyclopentadiene type epoxy resin “HP-7200H” (manufactured by DAINIPPON INK AND CHEMICALS, INCORPORATED: epoxy equivalent is 283: solid content of the resin is 80 weight percent), 57 weight parts of “EPICLON 730S” (manufactured by DAINIPPON INK AND CHEMICALS, INCORPORATED: epoxy equivalent is 180: solid content of the resin is 100 weight percent), 110 weight parts of melamine-modified cresol novolak resin “EXB-9854” (manufactured by DAINIPPON INK AND CHEMICALS, INCORPORATED: hydroxyl value is 151: solid content of the resin is 80 weight percent), 60 weight parts of benzooxazine compound “F-a” (manufactured by Shikoku Chemicals Corporation), 216 weight parts of siloxane-modified polyamide-imide resin (supplied by Hitachi Chemical Co., Ltd.: amide equivalent is 620: Mw=about 80000: solid content in resin is 28 weight percent), 15 weight parts of condensation type phosphoric ester “PX-200” (manufactured by DAIHACHI CHEMICAL INDUSTRY CO., LTD.), 0.7 weight parts of 2-ethyl-4-methyl-imidazole and 120 weight parts of silica filler treated with epoxy silane (average diameter of 0.3 μm). To the mixture, a mixed solvent of NMP/MEK was added to produce resin varnish having a solid content of 60 weight percent.

### Example 8

It was produced a mixture of 260 weight parts of dicyclopentadiene type epoxy resin “HP-7200H” (manufactured by DAINIPPON INK AND CHEMICALS, INCORPORATED: epoxy equivalent is 283: solid content of the resin is 80 weight percent), 60 weight parts of “EPICLON 850S” (manufactured by DAINIPPON INK AND CHEMICALS, INCORPORATED: epoxy equivalent is 187: solid content of the resin is 100 weight percent), 115 weight parts of melamine-modified cresol novolak resin “EXB-9854” (manufactured by DAINIPPON INK AND CHEMICALS, INCORPORATED: hydroxyl value is 151: solid content of the resin is 80 weight percent), 60 weight parts of benzooxazine compound “F-a” (manufactured by Shikoku Chemicals Corporation), 216 weight parts of siloxane-modified polyamide-imide resin (supplied by Hitachi Chemical Co., Ltd.: amide equivalent is 620: Mw=about 80000: solid content in resin is 28 weight percent), 15 weight parts of condensation type phosphoric ester “PX-200” (manufactured by DAIHACHI CHEMICAL INDUSTRY CO., LTD.), 0.7 weight parts of 2-ethyl-4-methyl-imidazole and 120 weight parts of silica filler treated with epoxy silane (average diameter of 0.3 μm)). To the mixture, a mixed solvent of NMP/MEK was added to produce resin varnish having a solid content of 60 weight percent.

### Example 9

It was produced a mixture of 372 weight parts of dicyclopentadiene type epoxy resin “HP-7200H” (manufactured by DAINIPPON INK AND CHEMICALS, INCORPORATED: epoxy equivalent is 283: solid content of the resin is 80 weight percent), 110 weight parts of melamine-modified cresol novolak resin “EXB-9854” (manufactured by DAINIPPON INK AND CHEMICALS, INCORPORATED: hydroxyl value is 151: solid content of the resin is 80 weight percent), 60 weight parts of benzooxazine compound “F-a” (manufactured by Shikoku Chemicals Corporation), 216 weight parts of siloxane-modified polyamide-imide resin (supplied by Hitachi Chemical Co., Ltd.: amide equivalent is 620: Mw=about 80000: solid content in resin is 28 weight percent), 15 weight parts of condensation type phosphoric ester “PX-200” (manufactured by DAIHACHI CHEMICAL INDUSTRY CO., LTD.), 0.7 weight parts of 2-ethyl-4-methyl-imidazole and 120 weight parts of silica filler treated with epoxy silane (average diameter of 0.3 μm). To the mixture, a mixed solvent of NMP/MEK was added to produce resin varnish having a solid content of 60 weight percent.

### Comparative Example 1

It was produced a mixture of 1300 weight parts of cresol nolovak-type epoxy resin “YDCN-704P” (manufactured by Tohto Chemical Co. Ltd.: epoxy equivalent of 210), 140 weight parts of bisphenol A type epoxy resin “EPICOAT 1001” (manufactured by JER Co. Ltd.: epoxy equivalent of 456: resin solid content is 70 weight percent), 327 weight parts of phenoxy resin “YP-55” (Tohto chemical Co. Ltd.:), 925 weight parts of melamine-modified phenol novolak resin “LA-7054” (manufactured by DAINIPPON INK AND CHEMICALS, INCORPORATED: hydroxyl value is 125: solid content of the resin is 60 weight percent), 240 weight parts of condensation type phosphoric ester “PX-200” (manufactured by DAIHACHI CHEMICAL INDUSTRY CO., LTD. ), 0.7 weight parts of 2-ethyl-4-methyl-imidazole and 320 weight parts of epoxydated polybutadiene resin “E-1800-6.5” (manufactured by Nippon Petrochemicals Co., Ltd). To the mixture, propylene glycol monomethyl ether (PGM) was added as a solvent to produce epoxy resin varnish having a solid content of 65 weight percent.

### Comparative Example 2

It was produced a mixture of 600 weight parts of brominated epoxy resin “EPICOAT 5045” (manufactured by JER Co. Ltd.: epoxy equivalent is 480: resin solid content is 80 weight percent), 85 weight parts of phenoxy resin “YP-55” (manufactured by Tohto chemical co. Ltd.), 13 weight parts of dicyan diamide, 0.5 weight parts of 2-ethyl-4-methyl-imidazole and 100 weight parts of epoxydated polybutadiene resin “E-1800-6.5” (manufactured by Nippon Petrochemicals Co., Ltd). To the mixture, propylene glycol monomethyl ether (PGM) and dimethyl formamide were added as mixed solvent to produce epoxy resin varnish having a solid content of 65 weight percent.

Each of the above described resin varnishes was sufficiently dispersed with a three roll mill. The dispersed varnish was applied onto a polyethylene terephthalate film (PET film) having a thickness of 25 μm and with mold releasing treatment, by means of a die coater, and dried at 150° C. to produce a thermosetting resin film (A) in B-stage having a thickness of 50 μm. The volatile matter content of the film was adjusted at 1.5 weight percent. A polyethylene film (PE film) was laminated on the resin film as a protective film.

The thus obtained body was laminated on a copper foil having a thickness of 18 μm without surface treatment and charged in a vacuum press to heat the laminate at 170° C. for 60 minutes at a pressure of 4 MPa and a degree of vacuum of 5 Torr to obtain a shaped body (shaped body (1)).

Further, a circuit was formed on a FR-4 double faced copper clad laminate of a high Tg, a thickness of 0.2 mm and free of halogen (copper foil of 12 μm) (product name: “TLC-W-552Y” manufactured by KYOCERA Chemical Corporation). The conductor of the circuit was subjected to a treatment with black copper oxide. After the protective film was peeled off from the above B-stage resin film, the resin films (A) were laminated on both sides of the copper-clad laminate. After the mold releasing film was peeled off, the resulting laminate was charged in a vacuum and heated at 170° C. for 60 minutes at 4 MPa and a degree of vacuum of 1 Torr to perform the shaping. The shaped body was cooled and removed from the vacuum press, and blind via holes each having a predetermined diameter was formed with CO₂ laser.

The shaped body was treated with permanganate desmear solution for surface roughening and for removing and dissolving residual resin on the bottom of the via hole. 0.8 μm of electroless plating of copper and 20 μm of electroplating of copper were formed on the laminate, which was then subjected to afterbaking at 170° C. for 30 minutes. The above process was repeated to obtain a 6-layer build-up printed wiring board (I) having two build-up layers on both sides of the board, respectively.

Further, the above varnishes were applied on both sides of a substrate film of full aromatic polyamide having a thickness of 16 μm with a die coater and then dried at 160° C. to obtain a thermosetting resin film (B) in B-stage having a thickness of 50 μm on the substrate film of full aromatic polyamide resin. Using the film (B), a shaped body (2) on a copper foil without surface treatment and a six-layer build-up multilayered printed wiring board (II) having two build-up layers on both sides, according to the procedures described above for the film (A).

Tables. 1, 3 and 5 show the parameters of the above examples, respectively. Tables 2, 4 and 6 show the results of evaluation of properties in the above examples, respectively.

TABLE 1

| | | Example 1 | Example 2 | Example 3 | Example 4 | Example 5 | Example 6 |
|---|---|---|---|---|---|---|---|
| (a) | epoxy equivalent | 283 | 275 | 265 | 275 | 283 | 283 |
| (a) | solid content (net weight) in composition | 297.6 | 289.6 | 279.2 | 289.6 | 297.6 | 297.6 |
| (a) | epoxy equivalent in composition | 1.052 | 1.053 | 1.054 | 1.053 | 1.052 | 1.052 |
| (b) | novolak-type phenol resin: hydroxyl value | 151 | 125 | 125 | 125 | 215 | 151 |
| (b) | novolak-type phenol resin: | 128 | 106.2 | 106.2 | 106.2 | 182 | 128 |
| | solid content (net weight) in composition | | | | | | |
| (b) | m | 0.806 | 0.807 | 0.806 | 0.807 | 0.805 | 0.806 |
| (b) | benzooxazine compound: hydroxyl value | 217 | 217 | 217 | 217 | 217 | 217 |
| (b) | benzooxazine compound: | 60 | 60 | 60 | 60 | 60 | 60 |
| | solid content (net weight) of composition | | | | | | |
| (b) | n | 0.262 | 0.262 | 0.262 | 0.262 | 0.262 | 0.262 |
| | m + n | 1.068 | 1.069 | 1.068 | 1.069 | 1.067 | 1.068 |
| (c) | siloxane-modified polyamide-imide resin | 12.5 | 13.3 | 13.6 | 13.3 | 11.2 | 8.4 |
| | solid content with respect to 100 weight parts of (a) + (b) | | | | | | |
| (d) | high molecular weight epoxy or phenoxy resin | 0 | 0 | 0 | 0 | 0 | 48.8 |
| | solid content with respect to 100 weight parts of (c) | | | | | | |
| (e) | filler: solid content with respect to | 22.0 | 23.2 | 23.7 | 23.2 | 20.0 | 22.0 |
| | 100 weight parts of (a) + (b) + (c) + (d) | | | | | | |

TABLE 2

| Items | | | Example 1 | Example 2 | Example 3 | Example 4 | Example 5 | Example 6 |
|---|---|---|---|---|---|---|---|---|
| Dielectric | Shaped body (1) | | 3.0 | 3.1 | 3.1 | 3.0 | 3.0 | 3.0 |
| Constant (1 GHz) | | | | | | | | |
| Dielectric loss | Shaped body (1) | | 0.009 | 0.008 | 0.008 | 0.008 | 0.009 | 0.010 |
| Tangent (1 GHz) | | | | | | | | |
| Tg(° C.): | Shaped body (1) | | 170 | 165 | 160 | 165 | 152 | 155 |
| TMA method | | | | | | | | |
| C.T.E(ppm/° C.) | Shaped body (1) | | 50 | 52 | 48 | 60 | 49 | 49 |
| | Shaped body (2) | | 16 | 16 | 15 | 18 | 15 | 16 |
| Surface roughness | PWB(I) | | 0.4 | 0.4 | 0.4 | 0.4 | 0.4 | 0.5 |
| Ra (μm) | | | | | | | | |
| Peel strength | | | 1.0 | 1.0 | 1.0 | 1.0 | 1.0 | 0.9 |
| (kN/m) | | | | | | | | |
| Reliability | PWB(III) | (a) | >500 | >500 | >500 | >500 | >500 | >500 |
| (a: cycles) | | (b) | >1,000 | >1,000 | >1,000 | >1,000 | >1,000 | >1,000 |
| (b: hrs) | PWB(IV) | (a) | >500 | >500 | >500 | >500 | >500 | >500 |
| | | (b) | >1,000 | >1,000 | >1,000 | >1,000 | >1,000 | >1,000 |

TABLE 3

| | | Example 7 | Example 8 | Example 9 |
|---|---|---|---|---|
| (a) | Epoxy equivalent | 238/180 | 283/187 | 283 |
| (a) | solid content (net weight) in composition | 208/57 | 208/60 | 297.6 |
| (a) | Epoxy equivalent in composition | 1.052 | 1.056 | 1.052 |
| (b) | Novolak-type phenol resin: hydroxyl value | 151 | 151 | 151 |
| (b) | Novolak-type phenol resin | 88 | 92 | 88 |
| | solid content (net weight) in composition | | | |
| (b) | m | 0.554 | 0.577 | 0.554 |
| (b) | Benzooxazine compound: hydroxyl value | 217 | 217 | 217 |
| (b) | Benzooxazine compound: solid content in | 60 | 60 | 60 |
| | composition | | | |
| (b) | n | 0.263 | 0.263 | 0.263 |
| | m + n | 0.817 | 0.840 | 0.817 |
| (c) | siloxane-modified polyamide-imide resin | 14.6 | 14.4 | 13.6 |
| | solid content with respect to | | | |
| | 100 weight parts of (a) + (b) | | | |
| (d) | High molecular weight epoxy or phenoxy resin: | 0 | 0 | 0 |
| | solid content with respect to | | | |
| | 100 weight parts of (c) | | | |
| (e) | filler: solid content with respect to | 25.3 | 25.0 | 23.7 |
| | (a) + (b) + (c) + (d) | | | |

TABLE 4

| Items | | | Example 7 | Example 8 | Example 9 |
|---|---|---|---|---|---|
| Dielectric constant | Shaped boy(1) | | 3.1 | 3.1 | 3.0 |
| (1 GHz) | | | | | |
| Dielectric loss | Shaped body | | 0.010 | 0.010 | 0.009 |
| tangent (1 GHz) | (1) | | | | |
| Tg(° C.): TMA [symbol] | Shaped body | | 165 | 166 | 176 |
| | (1) | | | | |
| C.T.E(ppm/° C.) | Shaped body | | 55 | 56 | 48 |
| | (1) | | | | |
| | Shaped body | | 17 | 17 | 15 |
| | (2) | | | | |
| Surface roughness | PWB(I) | | 0.5 | 0.5 | 0.4 |
| Ra(μm) | | | | | |
| Peel strength | | | 1.0 | 1.0 | 1.0 |
| (kN/m) | | | | | |
| Reliability | PWB(III) | (a) | >500 | >500 | >500 |
| (a: cycle) | | (b) | >1000 | >1000 | >1000 |
| (b: hrs) | PWB(IV) | (a) | >500 | >500 | >500 |
| | | (b) | >1000 | >1000 | >1000 |

TABLE 5

| | | Compar- | |
|---|---|---|---|
| | | aTive | Comparative |
| Items | | Example 1 | Example 2 |
| (a) | epoxy equivalent | 210/456 | 480 |
| (a) | net weight of solid content | 910/98 | 480 |
| | in composition | | |
| (a) | net epoxy equivalent in composition | 4.548 | 1 |
| (b) | novolak type phenol resin | 125 | — |
| | Hydroxyl value | | |
| (b) | novolak type phenol resin | 555 | — |
| | Net weight of solid content in composition | | |
| (b) | m | 1.024 | — |
| (b) | benzooxazine compound | — | — |
| | Hydroxyl value | | |
| (b) | benzooxazine compound | — | — |
| | Weight of solid content in composition | | |
| (b) | n | — | — |
| | m + n | — | — |
| (c) | siloxane-modified polyamide-imide resin | — | — |
| | solid content with respect to | | |
| | 100 weight parts of (a) + (b) | | |
| (d) | high molecular weight epoxy resin or | — | — |
| | phenoxy resin | | |
| | solid content with respect to | | |
| | 100 weight parts of (c) | | |
| (e) | filler | — | — |
| | solid content with respect to | | |
| | 100 weight parts of (a) + (b) + (c) + (d) | | |

TABLE 6

| | | | Comparative | ComparaTive |
|---|---|---|---|---|
| Items | | | Example 1 | Example 2 |
| Dielectric constant | Shaped body(1) | | 3.7 | 3.8 |
| (1 GHz) | | | | |
| Dielectric loss tangent | Shaped body(1) | | 0.016 | 0.018 |
| (1 GHz) | | | | |
| Tg(° C.): TMA method | Shaped body(1) | | 145 | 125 |
| C.T.E(ppm/° C.) | Shaped body(1) | | 85 | 80 |
| | Shaped body(2) | | 25 | 23 |
| Surface roughness | PWB(I) | | 1.0 | 0.9 |
| Ra (μm) | | | | |
| Peel strength (kN/m) | | | 0.8 | 1.0 |
| Relaiability | PWB(III) | (a) | 150 | 100 |
| (a: cycles) | | (b) | 300 | 150 |
| (b: hrs) | PWB(IV) | (a) | 100 | 50 |
| | | (b) | 200 | 100 |

PWB(III), PWB(IV):
Test pattern substrates produced according to “JPCA-HD01” and obtained by procedures of producing PWB(I) and PWB(II) described above

PWB (III) and PWB (IV) shown in tables 2, 4 and 6 are test pattern substrates of JPCA-HD01 produced according to procedures of PWB (I) and PWB (II), respectively.

Dielectric constant and dielectric loss tangent were measured with an impedance analyzer.

Reliability was evaluated by JPCA-BU01
(a) Thermal shock test: A sample was held at 125° C. for 30 minutes and then at −65° C. for 30 minutes in a single cycle. The number of the cycles performed is shown in table 2.
(b) High temperature and high humidity bias test: 85° C., 85% RH DC=30V (measured in a bath)

Ac described above, the present invention provides a resin composition for a high density build-up printed wiring board, having a low dielectric constant, low dielectric loss tangent, low thermal expansion coefficient, high adhesion strength and excellent heat resistance and reliability. A printed wiring board having such properties may be used for a plastic package of semiconductor.

The present invention has been explained referring to the preferred embodiments, however, the present invention is not limited to the illustrated embodiments which are given by way of examples only, and may be carried out in various modes without departing from the scope of the invention.

1. A thermosetting resin composition comprising:
(a) epoxy resin, (b) setting agents comprising a novolak-type phenol resin and a benzooxazine compound, and (c) a siloxane-modified polyamide-imide resin satisfying the following relationship,
0.6≦m+n≦2
0.5≦m≦1.2, and
0.1≦n≦1.0,
wherein “m” represents the hydroxyl group equivalent of (b) said novolak-type phenol resin with respect to the epoxy equivalent of (a) said epoxy resin of 1, and “n” represents the hydroxyl group equivalent of (b) said benzooxazine compound after thermal decomposition with respect to the epoxy equivalent of (a) said epoxy resin of 1,
and wherein said thermosetting resin composition comprises (c) said siloxane-modified polyamide-imide resin in a content of 2 to 50 weight parts with respect to the total content of (a) said epoxy resin and (b) said setting agent of 100 weight parts.

2. The resin composition of claim 1, further comprising (d) a high molecular weight epoxy resin or high molecular weight phenoxy resin in a weight not larger than that of (c) said siloxane-modified polyamide-imide resin.

3. The resin composition of claim 1, further comprising (e) a filler in a content of 100 weight parts or lower, with respect to the total content of (a) said epoxy resin, (b) said setting agents and (c) said siloxane-modified polyamide-imide resin of 100 weight parts.

4. The resin composition of claim 2, further comprising (e) a filler in a content of 100 weight parts or lower, with respect to the total content of (a) said epoxy resin, (b) said setting agents, (c) said siloxane-modified polyamide-imide resin and (d) said high molecular weight epoxy resin or high molecular weight phenoxy resin of 100 weight parts.

5. The resin composition of claim 1, wherein said epoxy resin is selected from the group consisting of biphenyl type epoxy resin, naphthalene type epoxy resin and dicyclopentadiene type epoxy resin.

6. The resin composition of claim 1, wherein said novolak-type phenol resin is selected from the group consisting of triazine-modified novolak resin, naphthol aralkyl type resin and naphthalene diol aralkyl resin.

7. The resin composition of claim 1, wherein said benzooxazine compound comprises a compound represented by the following formula (1) or (2), or the isomer or the oligomer of a compound represented by the following formula (1) or (2),

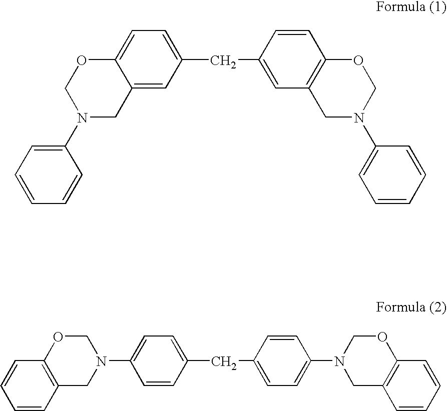

8. The resin composition of claim 1, wherein said siloxane-modified polyamide-imide resin (c) is obtained by reacting a trimellitic anhydride and a mixture of a diamine and siloxane diamine each having three or more aromatic rings to obtain a mixture containing diimide dicarboxylic acid, and by reacting said mixture containing diimide dicarboxylic acid with an aromatic diisocyanate.

9. The resin composition of claim 3, wherein said filler comprises a material selected from the group consisting of silica, poly(tetrafluoroethylene), polyphenylene ether and methyl silicone.

10. The resin composition of claim 4, wherein said filler comprises a material selected from the group consisting of silica, poly(tetrafluoroethylene), polyphenylene ether and methyl silicone.

11. A resin film in B-stage produced from the composition of claim 1.

12. A resin film in B-stage produced from the composition of claim 2.

13. A resin film in B-stage produced from the composition of claim 3.

14. A resin film in B-stage produced from the composition of claim 4.

15. A film article comprising the resin film of claim 11 and a substrate comprising a heat resistance film or metal foil.

16. A film article comprising the resin film of claim 12 and a substrate comprising a heat resistance film or metal foil.

17. A film article comprising the resin film of claim 13 and a substrate comprising a heat resistance film or metal foil.

18. A film article comprising the resin film of claim 14 and a substrate comprising a heat resistance film or metal foil.

19. The article of claim 15, wherein said heat resistant film comprises a full aromatic polyamide film or full aromatic polyester film.

20. The article of claim 16, wherein said heat resistant film comprises a full aromatic polyamide film or full aromatic polyester film.

21. The article of claim 17, wherein said heat resistant film comprises a full aromatic polyamide film or full aromatic polyester film.

22. The article of claim 18, wherein said heat resistant film comprises a full aromatic polyamide film or full aromatic polyester film.
